(19) United States
(12) Patent Application Publication
(10) Pub. No.: US 2009/0102535 A1
(43) Pub. Date: Apr. 23, 2009

(54) CLOCK SIGNAL CIRCUIT FOR MULTIPLE LOADS

(75) Inventors: CHUN-JEN CHEN, Tu-Cheng (TW); YU-CHANG PAI, Tu-Cheng (TW); SHOU-KUO HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,036

(22) Filed: Dec. 29, 2007

(30) Foreign Application Priority Data
Oct. 19, 2007 (CN) 200710202156.8

(51) Int. Cl. G06F 1/04

(52) U.S. Cl. 327/295

(57) ABSTRACT

A clock signal circuit for multiple loads includes a clock generator and M loads. The clock generator includes N clock generator pins which output clock signals having a same frequency. The N clock generator pins are all connected to a connection point. The connection point is connected to M loads via M transmitting lines respectively, wherein M is larger than N, M and N each is an integer greater than 2.

### BACKGROUND OF THE INVENTION

1. Field of the Invention

The present invention relates to a clock signal circuit for use with multiple loads.

2. Description of Related Art

With increasing numbers of loads being connected to integrated circuits (ICs), designers need to design for connection of one clock signal pin of a IC to more than one load. Referring to FIG. 4, a circuit diagram of a single clock signal pin coupling two loads of a conventional clock signal circuit is shown. A clock generator CLK1 includes a clock generator pin CLKOUT1. The clock generator pin CLKOUT1 is connected to two loads D11 and D12 via two transmitting lines 110 and 120 respectively. In this clock signal circuit, the load D11 or D12 receives a signal, which is only ½ the strength as the clock generator pin CLKOUT1 outputs.

FIG. 5 is a graph showing signal waveforms obtained at each load using the clock signal circuit of FIG. 4. A signal waveform X1 corresponds to the load D11 or D12 when lengths of the two transmitting lines 110 and 120 are each 4 inches. A signal waveform Y1 corresponds to the load D11 or D12 when lengths of the two transmitting lines 110 and 120 are each 20 inches. Table 1 shows slew rate of the signal each load receives compared with a standard slew rate. From the FIG. 5 and the Table 1, it can be seen that the signal waveform X1 meets the demand, but the signal waveform Y1 cannot meet the demand.

TABLE 1

| length of | rise slew | fall slew | |
|---|---|---|---|
| transmitting line | rate | rate | standard |
| 4 inches | 2.31 V/ns | 1.12 V/ns | 1 V/ns-4 V/ns |
| 20 inches | 1.12 V/ns | 0.84 V/ns | 1 V/ns-4 V/ns |

What is needed, therefore, is a circuit topology which can solve the above problem.

### SUMMARY

An exemplary clock signal circuit for multiple loads includes a clock generator comprising N clock generator pins which have a same frequency, and M loads, the N clock generator pins are all connected to a connection point, the connection point is connected to M loads via M transmitting lines respectively, wherein M is larger than N, M and N each is an integer greater than 2.

Other objects, advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a block diagram of a clock signal circuit for multiple loads in accordance with an embodiment of the present invention;

FIG. 2 is a graph showing signal waveforms obtained at each load using the circuit topology of FIG. 1;

FIG. 3 is a block diagram of a clock signal circuit for multiple loads in accordance with another embodiment of the present invention;

FIG. 4 is a circuit diagram of a single clock signal pin coupling two loads of a conventional clock signal circuit; and

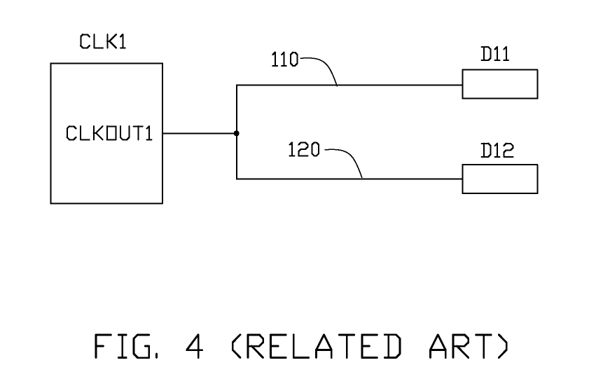

FIG. 5 is a graph showing signal waveforms obtained at each load using the circuit topology of FIG. 4.

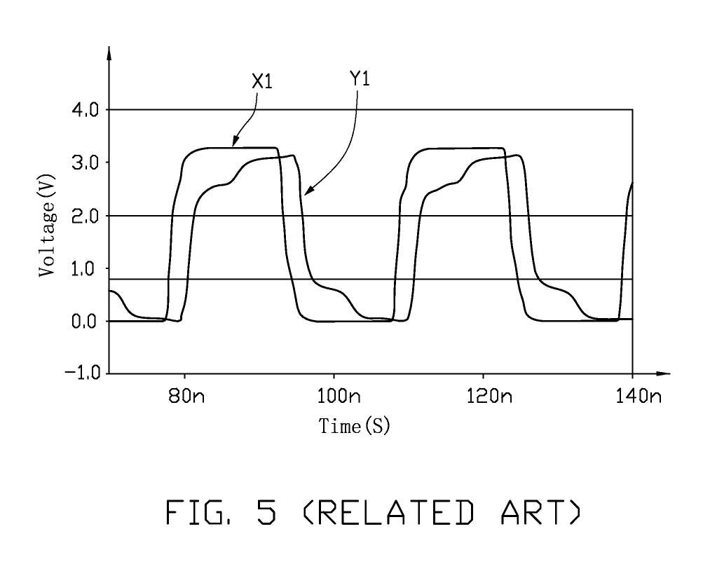

### DETAILED DESCRIPTION

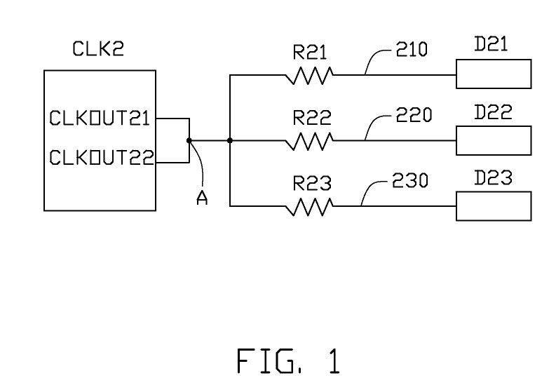

Referring to FIG. 1, a clock signal circuit for multiple loads in accordance with an embodiment of the present invention includes a clock generator CLK2, and three loads D21, D22, and D23. The clock generator CLK2 includes two clock signal pins CLKOUT21 and CLKOUT22, which have a same frequency. The two clock signal pins CLKOUT21 and CLKOUT22 are connected to a connection point A. The connection point A is connected to the three loads D21, D22, and D23 via three transmitting lines 210, 220, 230 respectively. Three resistors R21, R22, and R23 each chosen with a resistance for impedance matching are connected in the three transmitting lines 210, 220, and 230 respectively.

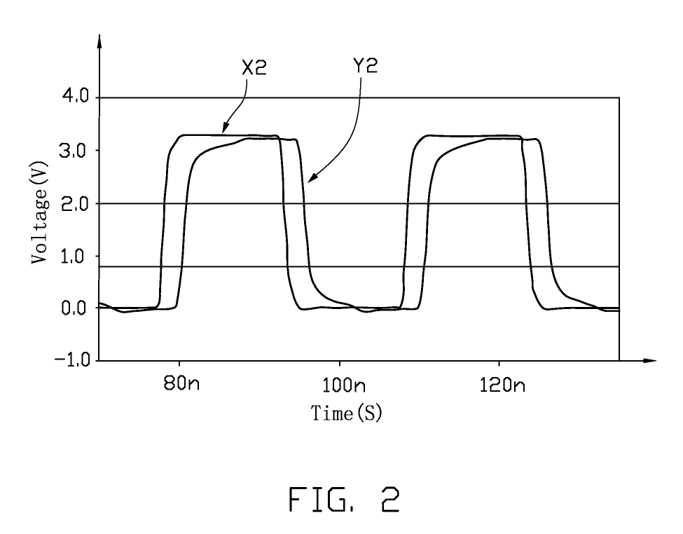

FIG. 2 is a graph showing signal waveforms obtained at each load using the clock circuit for multiple loads of FIG. 1. A signal waveform X2 corresponds to the load D21, D22, or D23 when lengths of the three transmitting lines 210, 220, and 230 are all 4 inches. A signal waveform Y2 corresponds to the load D21, D22, or D23 when lengths of the three transmitting lines 210, 220, and 230 are all 20 inches. In the clock circuit for multiple loads of FIG. 1, a signal each load receives is ⅔ the strength each signal pin generates. Table 2 is showing the rise slew rate and the fall slew rate of the signal each load receives compared with the standard slew rate. As shown in the FIG. 2 and the Table 2, the signal waveform X2 and the signal waveform Y2 both meet the demand.

TABLE 2

| length of | rise slew | fall slew | |
|---|---|---|---|
| transmitting line | rate | rate | standard |
| 4 inches | 3.1 V/ns | 2.39 V/ns | 1 V/ns-4 V/ns |
| 20 inches | 2.1 V/ns | 1.79 V/ns | 1 V/ns-4 V/ns |

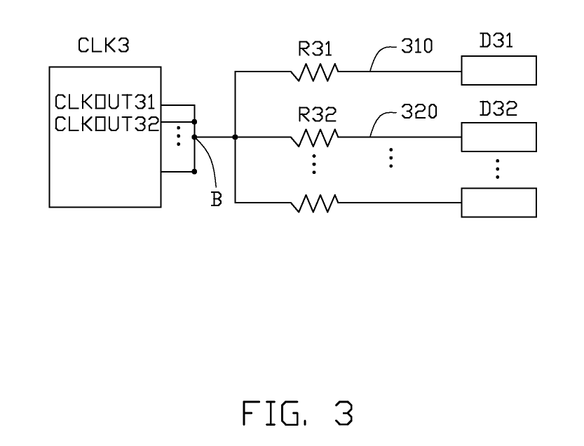

Referring also to FIG. 3, a clock signal circuit for multiple loads in accordance with another embodiment of the present invention includes a clock generator CLK3 and M loads 310, 320 . . . . The clock generator CLK3 includes N clock signal pins CLKOUT31, CLKOUT32 . . . , which have a same frequency. The N clock signal pins CLKOUT31, CLKOUT32 . . . are all connected to a connection point B. The connection point B is connected to N loads via M transmitting lines 310, 320 . . . respectively. M resistors R31, R32 . . . are respectively connected in the M transmitting lines 310, 320 . . . . The resistance of each resistor is chosen to accomplish impedance matching of the corresponding transmitting line. Wherein M is larger than N, M and N each is an integer greater than 2.

In this embodiment, the circuit topology provides that the signal each load receives is N/M times the strength each clock signal pin generates, and so the strength of the signal each load receives is enhanced compared to conventional topologies. The slew rate of the signal each load receives meets the demand.

In the above-described clock signal circuit of the another embodiment of the present invention, it makes the clock signal pins be connected to a connection point, and the connection point be connected to the loads via the transmitting lines respectively. Thus enhance the signal each load receives and the slew rate of the signal to meet the demand.

The foregoing description of the exemplary embodiment of the invention has been presented only for the purposes of illustration and description and is not intended to be exhaustive or to limit the invention to the precise forms disclosed. Many modifications and variations are possible in light of the above teaching. The embodiment was chosen and described in order to explain the principles of the invention and its practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. A clock signal circuit for multiple loads comprising: a clock generator and M loads, the clock generator including N clock generator pins which output clock signals having a same frequency, the N clock generator pins connected to a connection point, the connection point connected to M loads via M transmitting lines respectively, wherein M is greater than N, M and N each is an integer greater than 2.

2. The clock signal circuit for multiple loads as claimed in claim 1, wherein a resistor is connected between the connection point and each of the loads.

3. The clock signal circuit for multiple loads as claimed in claim 2, wherein the resistance of each resistor is chosen to accomplish impedance matching of the transmitting line accordingly.
